(19) United States
(12) Patent Application Publication
(10) Pub. No.: US 2022/0335010 A1
(43) Pub. Date: Oct. 20, 2022

(54) SYNCHRONIZATION SYSTEM AND METHOD

(71) Applicant: Core Scientific, Inc., Bellevue, WA (US)

(72) Inventors: Lito Bejarano Borrega Angel, Cáceres (ES); Ian Ferreira, Issaquah, WA (US)

(21) Appl. No.: 17/723,202

(22) Filed: Apr. 18, 2022

Related U.S. Application Data
(60) Provisional application No. 63/176,836, filed on Apr. 19, 2021.

(51) Int. Cl. G06F 16/178; G06F 16/14; G06F 16/182

(52) U.S. Cl. CPC G06F 16/178; G06F 16/152; G06F 16/182

(57) ABSTRACT

A synchronization system configured to identify a first workload file on a central storage and identify a first workload file on a compute system remote from the central storage. The synchronization system determines if the first workload file on the central storage is different than the first workload file on the compute system. If the two first workload files are different, the synchronization system automatically copies the first workload file on the central storage to the compute system so the a compute system workload will be performed using the copy of the first workload file from the central storage and the compute system workload will not be performed using the first workload file on the compute system.

### CROSS REFERENCE TO RELATED APPLICATIONS

This application claims priority to Provisional Patent Application No. 63/176,836, filed on Apr. 19, 2021 and is hereby incorporated by reference in its entirety.

### TECHNICAL FIELD

The present disclosure generally relates to managing workload files employed by compute systems.

### SUMMARY

Systems and methods are presented herein that include a synchronization system or interface that operates as an arbiter of truth between a central storage or repository and compute systems.

The synchronization system may, for example, determine that a workload file, such as File X, exists on both the central storage and a compute system, and that the compute system needs to operate on File X (e.g., perform a workload with File X). If the synchronization system determines that the copy of File X on the compute system is not the same as File X on central storage, the synchronization system automatically copies File X from central storage to the compute system so the workload will be performed using the copy from central storage and not the copy pre-existing on the compute system.

The synchronization system may also, for example, determine that a workload file, such as File X, exists on the compute system, but not on central storage. The synchronization system may, therefore, automatically copy File X from the compute system to central storage.

Other aspects of the synchronization system are presented herein.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Users often employ compute systems (e.g., cloud computing services such as Amazon Web Services, Azure, or Kubernetes and/or bare metal computing systems) to carry out workloads. Further, for performance and/or cost reasons, a user may employ more than one of these compute systems. That is, one compute system may be chosen for certain workloads, while another compute system may be chosen for different workloads based on performance metrics. Additionally, or alternatively, a user may select a compute system based on the costs of use. Since costs can fluctuate, a user may alternate between different compute systems in order to save money.

When using a compute system, a user may upload a file to the system and, in turn, the system implements an application or software package generally chosen by the user to carry out operations using the uploaded file. A modified, new, and/or unchanged file may be output by the compute system. Since compute systems often charge based on units of time, the user may then download the updated or new output file(s), along with unchanged files, so the compute session may be closed so no further costs are incurred. At a later time, these downloaded files may again be used as inputs for workloads driven by a compute system and, in turn, additional modified, new, and/or unchanged files may be created. Accordingly, the amount of output files, or workload files, the user must manage may quickly increase.

When a user is employing multiple compute systems for a project, the project may be carried out over multiple compute sessions and the number of files that need to be managed can become overwhelming, or at least time consuming. Further, the difficulties in managing files can create the unfortunate situation where the most up-to-date files are not used during a compute session. That is, a user may inadvertently use an outdated workload file(s) as a workload input during compute sessions resulting in wasted time and expense.

For at least these reasons, there is a desire for an improved system and method for efficiently creating and managing workload files. The foregoing discussion is intended only to illustrate examples of the present field and is not a disavowal of scope.

### BRIEF DESCRIPTION OF THE DRAWINGS

FIG. 1 is a schematic view generally illustrating an example embodiment of a distributed computing system according to teachings of the present disclosure;

FIG. 2 is a schematic view generally illustrating another exemplary distributed computing system according to teachings of the present disclosure;

FIG. 3 is a flowchart representing an exemplary file synchronization technique according to teachings of the present disclosure; and

FIG. 4 is a schematic view illustrating examples of a synchronization system in operation according to the teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not limit the present disclosure to these embodiments and/or examples. On the contrary, the present disclosure covers alternatives, modifications, and equivalents.

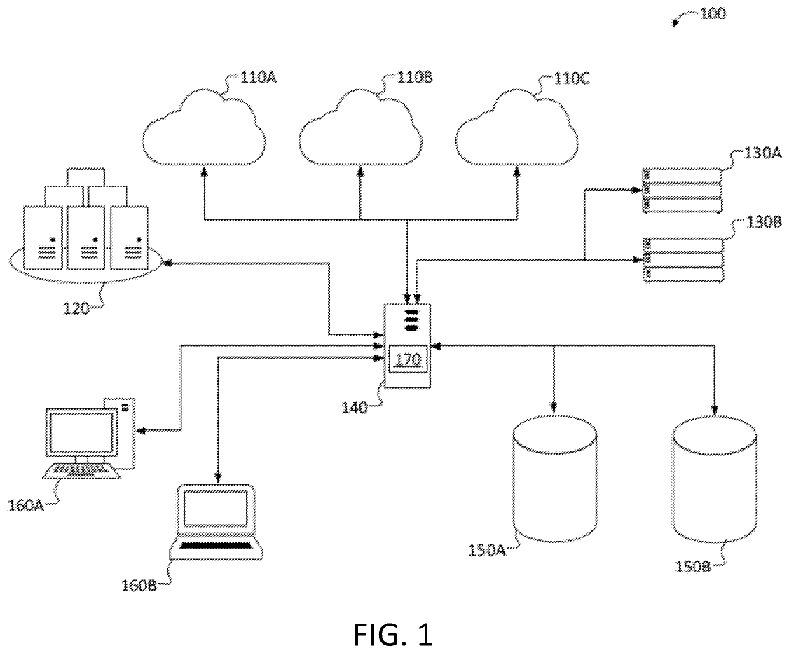

Turning now to FIG. 1, an example of a distributed computing system 100 according to teachings of the present disclosure is shown. In this example, the exemplary distributed computing system 100 is managed by an exemplary management server 140, which may for example provide access to the distributed computing system 100 by providing a platform as a service (PAAS), infrastructure as a service (IAAS), or software as a service (SAAS) to users. Users may access these PAAS/IAAS/SAAS services from their on-premises network-connected PCs, workstations, or servers (160A) and laptop or mobile devices (160B) via a web interface.

Management server 140 is connected to a plurality of different compute systems and/or devices via local or wide area network connections. This may include, for example, cloud computing providers 110A, 110B, and 110C. These cloud computing providers may provide access to large numbers of computing devices (often virtualized) with different configurations. For example, systems with one or more virtual CPUs may be offered in standard configurations with predetermined amounts of accompanying memory and storage. In addition to cloud computing providers 110A, 110B, and 110C, management server 140 may also be configured to communicate with compute systems such as bare metal computing devices 130A and 130B (e.g., non-virtualized servers), as well as a datacenter 120 including for example one or more supercomputers or high-performance computing (HPC) systems (e.g., each having multiple nodes organized into clusters, with each node having multiple processors and memory), and storage systems 150A and 150B. Bare metal computing devices 130A and 130B may for example include workstations or servers optimized for machine learning computations and may be configured with multiple CPUs and GPUs and large amounts of memory. Storage systems 150A and 150B may include storage that is local to management server 140 and well as remotely located storage accessible through a network such as the internet. Storage systems 150A and 150B may comprise storage servers and network-attached storage systems with non-volatile memory (e.g., flash storage), hard disks, and even tape storage.

Management server 140 is configured to run an exemplary distributed computing management application 170 that receives jobs and manages the allocation of resources from distributed computing system 100 to run them. Management application 170 is preferably implemented in software (e.g., instructions stored on a non-volatile storage medium such as a hard disk, flash drive, or DVD-ROM), but hardware implementations are possible. Software implementations of management application 170 may be written in one or more programming languages or combinations thereof, including low-level or high-level languages. The program code may execute entirely on the server 140, partly on server 140 and partly on other computing devices in distributed computing system 100.

The management application 170 may be configured to provide an interface to users (e.g., via a web application, portal, API server or command line interface) that permits users and administrators to submit applications/jobs via their workstations 160A and laptop or mobile devices 160B, designate the data sources to be used by the application, designate a destination for the results of the application, and set one or more application requirements (e.g., parameters such as how many processors to use, how much memory to use, cost limits, application priority, etc.). The interface may also permit the user to select one or more system configurations to be used to run the application. This may include selecting a particular bare metal or cloud configuration (e.g., use cloud A with 24 processors and 512 GB of RAM).

Management server 140 may be a traditional PC or server, a specialized appliance, one or more nodes within a cluster (e.g., running with a virtual machine or container). Management server 140 may be configured with one or more processors (physical or virtual), volatile memory, and non-volatile memory such as flash storage or internal or external hard disk (e.g., network attached storage accessible to server 140).

Management application 170 may also be configured to receive computing jobs from user devices 160A and 160B, determine which of the distributed computing system 100 computing resources are available to complete those jobs, make recommendations on which available resources best meet the user's requirements, allocate resources to each job, and then bind and dispatch the job to those allocated resources. In one example, the jobs may be configured to run within containers (e.g., Kubernetes with Docker containers, or Singularity) or virtualized machines on the distributed computing system 100. Kubernetes is an open-source system for automating deployment, scaling, and management of containerized applications. Singularity is a container platform popular for high performance workloads such as artificial intelligence and machine learning.

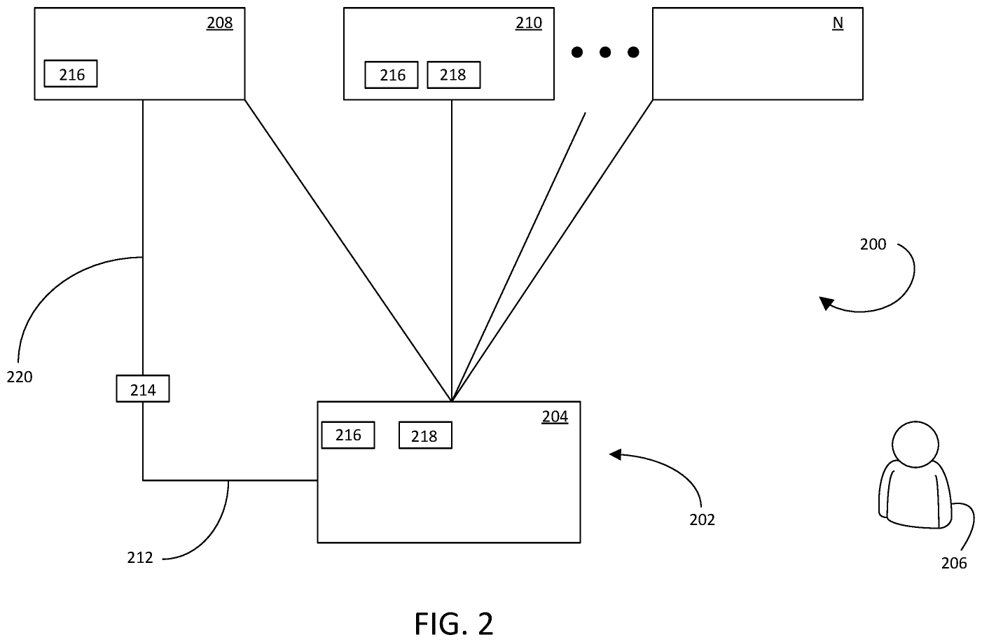

Turning now to FIG. 2, a schematic view of another exemplary distributed computing system 200 is shown. The distributed computing system includes an exemplary synchronization system 202 having, or at least having access to, an exemplary central storage 204. The synchronization system 202 may, for example, be implemented or controlled by a distributed computing management application (see, e.g., application 170 of FIG. 1). The synchronization system 202 of FIG. 2 enables a user 206 to efficiently operate over multiple compute systems (e.g., multiple cloud computing services and/or bare metal systems), where one or more of the compute systems may be performing a respective workload for the user 206 at any given time.

The distributed computing system 200 may include any number of compute systems. Further, the user 206 may employ one or more of these computing systems at any given time. There are a variety of reasons a user may want access to multiple compute systems. For example, one or more compute systems may have particular performance characteristics that others lack. Further, while one compute system may excel at one task(s), another compute system may excel at a different task(s). Still further, the costs to use compute systems may vary based on, for example, these performance characteristics or other metrics. As such, cost considerations and performance considerations may effect a user's desire to use any given compute system at any given time. Accordingly, having the option to access more than one compute system generally serves as a great benefit for the user (e.g., user 206).

For exemplary purposes, the distributed computing system 200 of FIG. 2 includes N compute systems. That is, the distributed computing system 200 includes a first compute system 208, a second compute system 210, and an N compute system. The synchronization system 202, which may reside with the central storage 204, may be accessible to each of the compute systems 208-N.

As mentioned, the synchronization system 202 allows for efficient interactions among multiple compute systems 208-N (e.g., cloud computing services). For example, the user 206 may copy 212 a file 214 (a.k.a. a workload file) to central storage 204 to create a synchronization file 216. The synchronization file 216 is then automatically accessible to each of the compute systems 208-N. As such, the synchronization file 216 need not be stored on every cluster (e.g., compute systems 208-N) that the user 206 may potentially employ. Since compute systems may charge for storage, costs can also be minimized.

The user 206 may request, for example, that the second compute system 210 carry out a workload. If the workload employs the synchronization file 216, and the workload is initiated, the synchronization system 202 automatically copies the synchronization file 216 to the second cloud compute system 210. That is, the synchronization system 202 generally only populates any given compute system 208-N when the user 206 requests the given system(s) performs a workload.

If, for example, the second compute system 210 operates on the synchronization file 216 and changes the synchronization file to create a changed synchronization file 218 (either a new file or a modified file), the synchronization system 202 automatically copies the changed file 218 of the second compute system to the central storage 204. In turn, the changed file 218 copied to the central storage 204 is then automatically accessible to each of the compute systems 208-N. In a similar manner, a file on other compute systems 208, N may be altered or created and copied to the central storage 204.

Due to the manner in which the synchronization system 202 ensures that any new or altered copy created on a compute system is copied to the central storage 204, the synchronization file 216, or updated synchronization file 218, need not be stored on every cluster (e.g., compute systems 208-N) that the user 204 may potentially employ.

The file 214 need not be copied directly 212 to central storage 204. For example, instead of copying the file 214 directly to central storage 204, the file 214 may be copied 220 first to the first compute system 208. Before or after the first compute system 206 operates on the file 216 (e.g., when a workload is initiated on the first compute system 208), the synchronization system 202 may copy the file 216 to the central storage 204. Accordingly, the file 216 will be automatically accessible to each compute system 208-N. In a similar manner, the file 214 may instead be initially copied to a different compute system 210-N and then copied to the central storage 204 in the manner described above.

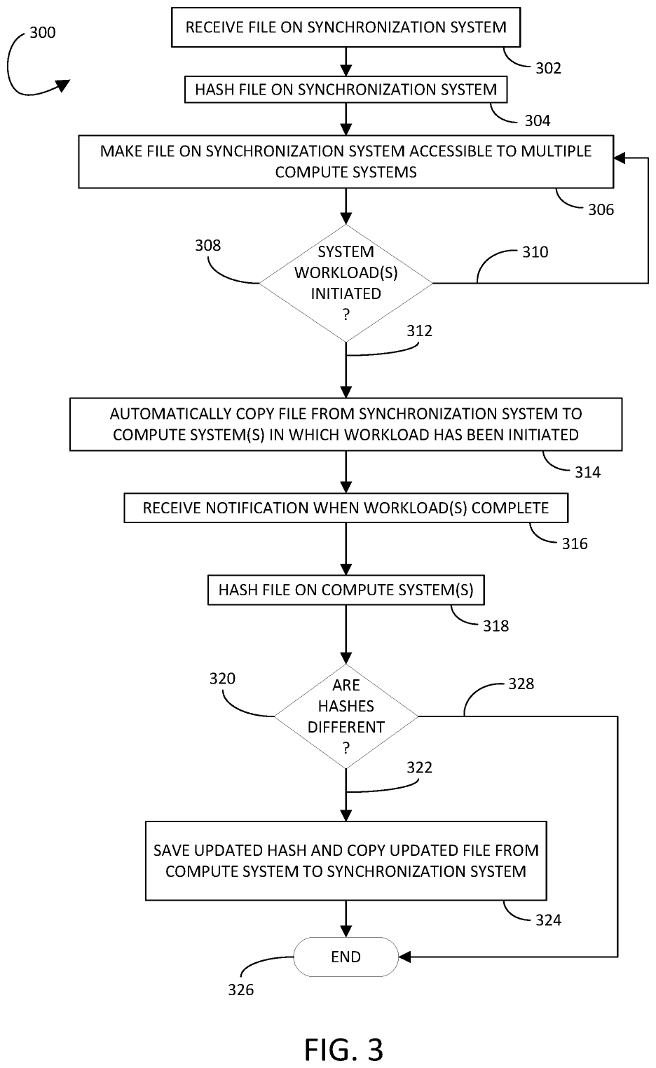

With reference now to FIG. 3, a flowchart is shown representing an exemplary file synchronization technique 300 for efficient file synchronization across multiple compute systems (e.g., cloud computing services and/or bar metal compute systems). Process control begins at BLOCK 302, where a workload file is received on a synchronization system. The file may be either uploaded to the synchronization system or downloaded from one of the compute systems. Further, the synchronization system may be a component of a distributed computing management application (see, e.g., application 170 of FIG. 1).

With continued reference to FIG. 3, once the workload file is received on the synchronization system, a hash of the file is saved by the synchronization system. The hash may, for example, be a single hash that represents a hash of the entire file. Alternatively, the hash may be comprised multiple hashes, each respectively associated with a chunk of the file. Other identifying attributes of the files may also be saved to the synchronization system (e.g., a date/time stamp and/or checkpoint files). Once hashed, the synchronization system makes the file accessible to one or more compute systems at BOCK 306 and determines, at BLOCK 308, if a workload on a compute system(s) is initiated. Whether or not a workload is initiated at BLOCK 308 may be dependent on a user. For example, a user may be given the opportunity to initiate a workload on one or more compute systems. Additionally, or alternatively, the user may employ a script that causes the one or more compute systems to initiate a one or more workloads in a predefined manner.

Regardless on the manner in which a workload is initiated or is not initiated, if process control determines that a workload is not initiated 310 on a compute system, process control proceeds back to block 306, where the file remains accessible to the one or more compute systems.

If, on the other hand, the synchronization system determines a workload is initiated 312 on one or more compute systems, the relevant workload file is automatically copied to that compute system(s) at BLOCK 314. While not shown, process control may cause the workload file copied to the compute system to be rehashed. As such, the hash of the file on the synchronization system (304) can be compared to the hash of the copied file to ensure no errors occurred as the file on the synchronization system was copied to the compute system.

Referring back to FIG. 3, after the synchronization system copies the workload file(s) to the relevant compute system(s) at BLOCK 314, process control proceeds to BLOCK 316, where the synchronization system receives notification when the workload is complete. If multiple workloads are operating over multiple respective compute systems, the synchronization system will receive notification when each workload is complete. The notification received by the synchronization system may, for example, be provided by the compute system when the workload is complete. As another example, a user may cause or command the workload to complete, thus causing the synchronization system to be notified that the workload is complete.

After notification is received, the synchronization system hashes the file on the compute system at BLOCK 318. A script operating on the compute system, but controlled by the synchronization system, may create the hash (or chunk hashes). This hash may then be stored in, for example, temporary storage on the compute system.

At BLOCK 320, the synchronization system determines if the hash stored on the compute system is different than the hash of the file on the synchronization system. Since a hash (or batched hashes) uniquely represents a file, if the hashes are different, then the two files are different (i.e., one file has been modified or a new file has been created). Alternatively, if the hashes are the same, the two files are not different. That is, if the hashes are the same, the workload did not change the file.

The synchronization system may be configured to cause each file on the compute system to be hashed. After a compute system carries out a workload using a file copied to the compute system, at least one of the following exemplary scenarios may occur: i) the compute system file remains unmodified; ii) the compute system file is modified such that information is added and/or deleted from the file (e.g., modify lines of a spreadsheet); iii) the compute system file remains unchanged, but a new file is created therefrom as an output (e.g., a PDF file remains unchanged and a new optical character recognition PDF file is created therefrom); and/or iv) the compute system file is modified and a new file is created as an output. As such, if a comparison of the hash on the synchronization system is compared to each hashed file operated on by the workload(s), the synchronization system can determine if a file remains unchanged, changed, and/or if a new file has been created.

Accordingly, if the hash of any workload file on the compute system(s) is different 322 than the hash on the synchronization system, process control proceeds to BLOCK 324 and the updated (different) hash and file is copied from the compute system to the synchronization system. In other words, any new or modified workload file on the compute system is automatically copied to the synchronization system along with its current hash. Process control then proceeds to an end 326.

If, on the other hand, it is determined at BLOCK 320 that the hashes are not different 328, the synchronization system does not copy any workload files from the compute system and process control proceeds to the end 326. Effectively, unchanged hashes 328 determine that the workload file(s) on the compute system is not different than the workload file(s) on the synchronization system. As such, for the sake of efficiency and reliability, a file is not copied from the compute system back to the synchronization system.

While not shown, prior to proceeding from BLOCK 324, the synchronization system may rehash the workload file copied to the synchronization system from the compute system and compare the rehash to the previously saved hash. Accordingly, the synchronization system can ensure that an accurate copy of the file was received from the compute system. To put another way, the synchronization system can verify that there were no errors in the transmission of the workload file to the synchronization system.

The synchronization technique 300 represented in FIG. 3 allows for an efficient use of resources and effectively manages downloads from compute system(s). For example, instead of storing a file on each compute system, the file is instead stored on the synchronization system (e.g., on a central storage or repository) and remains accessible to each compute system when needed. Since compute systems may charge a fee for persistent storage, costs can be minimized by using the synchronization system for persistent storage instead of each compute system the user has access too. Further, redundant workload files (files with the same hash) are not downloaded from compute systems to the synchronization system or central storage.

In a similar manner to technique 300, the synchronization system may also manage files that are uploaded to compute systems. For example, if a compute system needs a workload file, the synchronization system may automatically copy the relevant workload file to the compute system. However, the synchronization system may, for example, determine that a workload file, such as File X, exists on both the central storage and a compute system, and that the compute system needs to operate on File X (e.g., perform a workload with File X). By comparing hashes, the synchronization system may determine that the copy of File X on the compute system is not the same as File X on central storage. As such, the synchronization system may automatically copy File X from central storage to the compute system so the workload will be performed using the copy from central storage and not the copy pre-existing on the compute system.

Alternatively, via comparing hashes, the synchronization system may determine that the copy of File X on the compute system is the same as File X on central storage. As such, the synchronization system will not copy File X from central storage to the compute system, thus avoiding redundant operations and minimizing the potential of inaccurate (corrupt) data transmission.

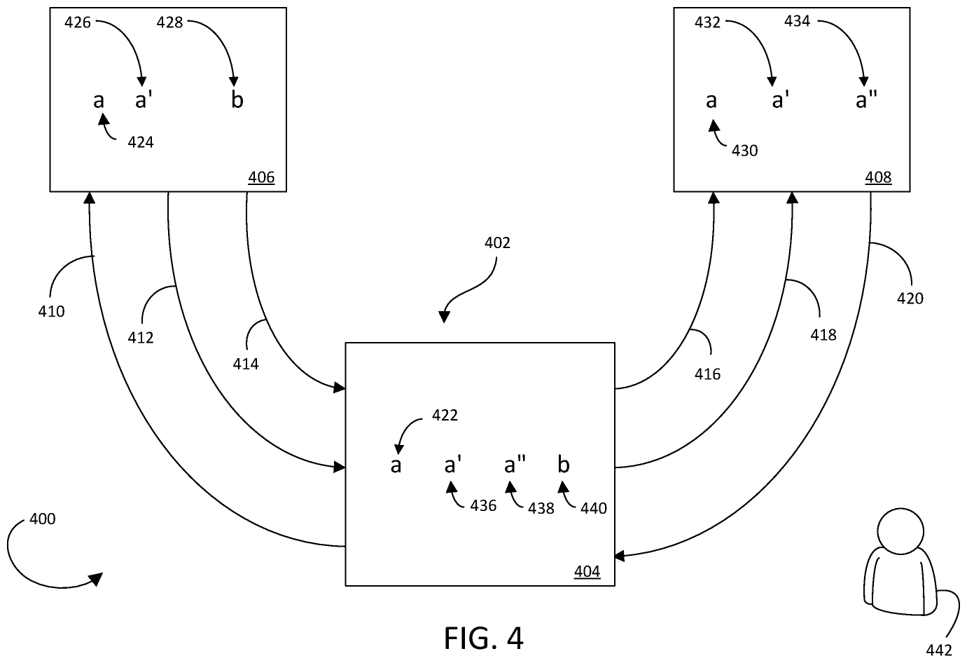

Turning now to FIG. 4, a schematic view 400 illustrating examples of an exemplary synchronization system 402 in operation is shown. In the representations illustrated in FIG. 4, the synchronization system 402 is interfacing with an exemplary central storage 404 or repository and is configured to interact with two exemplary compute systems 406, 408. The two compute systems 406-408 may, for example, be cloud computing services, bare-metal systems (onsite or remote), or a combination of both. These compute systems 406-408 may include, generally, any number of computing devices (e.g., one to thousands or more).

The synchronization system 402 or interface operates as an arbiter of truth between a central storage 404 or repository and compute systems 406-408. Further, the synchronization system 402 is configured to efficiently synchronize information among the two compute systems 406-408.

While FIG. 4 includes only two compute systems 406-408 for illustrative purposes, the synchronization system 402 may operate among more than two compute systems in the manner set forth above, and in the manner described in further detail below.

In addition to the synchronization system 402 and the compute systems 406-408, FIG. 4 also figuratively illustrates a plurality of exemplary workloads file transfers. That is, a first, second, and third workload file transfer 410, 412, 414, respectively, related to the first compute system 406 are represented, while a fourth, fifth, and sixth workload file transfer 416, 418, 420, respectively, related to the second compute system 408 are also represented. These workloads file transfers 410-420 are merely exemplary. That is, the synchronization system 402 is configured to engage with more than two compute systems and is configured to carry out different and/or additional workload file transfers than those shown and discussed below.

Also represented in FIG. 4 is a plurality of exemplary workload files. On the central repository 404 is a first workload file (File (a) 422) and on the first compute system 406 is a copy of the first workload file (File (a) 424). Further, a modified first workload file (File (a′) 426) is represented on the first compute system 406. File (a′) 426 is File (a) 424 with modifications. File (a) 424 may, for example, be a spreadsheet file and File (a′) 426 may be the same spreadsheet file, except with lines added or deleted. Other types of workload and modified workload files are envisioned. A new file (File (b) 428) is also shown on the first compute system 406. File (b) 428 may take a wide variety of forms and further details will be set forth below.

On the second compute system 408, another copy of the first workload file (File (a) 430), a modified workload file (File (a′) 432), and a further modified first workload file (File (a″) 434) are represented. This further modified first workload, File (a″) 434, represents a modification of File (a′) 432, which in turn is a modification of File (a) 430.

Referring back to the central storage 404, a copy of the modified first workload file (File (a′) 436), a copy of the further modified first workload file (File (a″) 438), and a copy of the new file (File (b) 440) are also represented.

Examples of the interaction between the workload files 422-440, the workload file transfers 410-420, and the synchronization system 402 follows. Further, additional insight can be found when the examples below are read in light of the above-discussion regarding the exemplary synchronization technique 300 of FIG. 3.

Unless stated otherwise in examples or scenarios, reference to the terms first, second, third, fourth, fifth, sixth, and etc. do not imply order of operation, but rather, are merely used as identifiers.

### EXAMPLE I

The initial conditions for Example I follow: File (a) does not exist on the first compute system 406 and the user 442 has initiated a first workload on the first compute system 406, which is configured to operate on File (a).

Accordingly, the synchronization system 402 automatically determines that File (a) does not yet exist on the first compute system 406 (see initial conditions). In response, and since File (a) 422 on central storage 404 is accessible to each compute system 406-408, the synchronization system 402 automatically initiates the first workload file transfer 410 to copy File (a) 422 of central storage 404 to the first compute system 406 as File (a) 424. As such, upon completion of the first workload file transfer 410, File (a) 424 now exists on the first compute system 406.

### EXAMPLE II

The initial conditions for Example II follow: File (a) 424 exists on the first compute system 406; the user 442 has initiated a first workload on the first compute system 406, where the first workload is configured to operate on File (a); and File (a) 424 on the first compute system 406 is not the same as File (a) 422 residing on central storage 404.

In light of the initial conditions, the synchronization system 402 automatically determines that File (a) 424 exists on the first compute system 406 and File (a) 422 exists on central storage. In response, the synchronization system 402 automatically compares a hash of File (a) 424 residing on the first compute system 406 with a hash of File (a) 422 residing on central storage 404. Since, according to the initial condition of this example, File (a) 424 of the first compute system 406 is not the same as File (a) 422 of central storage 404, the synchronization system 402 determines that the compared hashes are not the same.

As such, since central storage 404 is considered the source of truth when two files do not match, the synchronization system 402 automatically initiates the first workload file transfer 410 to copy File (a) 422 of central storage 404 to the first compute system 406 as File (a) 424 to overwrite File (a) that was pre-existing (according to the initial conditions) on the first compute system 406. The synchronization system 402, therefore, ensures that a file stored on central storage 404 takes precedence when there is a conflict (e.g., a File (a) on central storage does not match a File (a) stored on a compute system).

### EXAMPLE III

The initial conditions for Example III follow: File (a) 424 exists on the first compute system 406; the user 442 has initiated a first workload on the first compute system 406, where the first workload is configured to operate on File (a); and File (a) 424 on the first compute system 406 is the same as File (a) 422 residing on central storage 404.

In light of the initial conditions, the synchronization system 402 automatically determines that File (a) 424 exists on the first compute system 406 and File (a) 422 exists on central storage 404. In response, the synchronization system 402 automatically compares a hash of File (a) 424 residing on the first compute system 406 with a hash of File (a) 422 residing on central storage 404. Since, according to the initial condition of this example, File (a) 424 of the first compute system 406 is the same as File (a) 422 of central storage 404, the synchronization system 402 determines that the compared hashes are the same.

As such, the first workload transfer 410 is not initiated and the first workload operates on the File (a) 422 already pre-existing on the first compute device.

The synchronization system 402, therefore, manages the files in an efficient manner while also avoiding the redundant transfer of data, where inadvertent transmission errors could be propagated.

### EXAMPLE IV

The initial conditions for Example IV follow: File (a) 424 exists on the first compute system 406; the user 442 has initiated a second workload on the first compute system 406, where the second workload is configured to operate on File (a) 424 to create a modified File (a′) on the first compute system 406; and File (a′) does not exist on central storage 404.

Upon completion of the second workload on File (a) 424, File (a′) 426 is created on the first compute system 406. The synchronization system 402 then automatically determines that File (a′) 426 exists on the first compute system 406, but File (a′) does not exist on central storage 404 (see initial conditions). As such, the synchronization system 402 automatically initiates the second workload transfer 412, and File (a′) 426 of the first compute system 406 is copied to central storage 404 as File (a′) 436. Once copied to central storage 404, File (a′) 436 on central storage will automatically become accessible to each compute system 406-408.

### EXAMPLE V

The initial conditions for Example V follow: File (a) 424 exists on the first compute system 406; the user 442 has initiated a third workload on the first compute system 406, where the third workload is configured to operate on File (a) 424 in order to create a new file (File (b)); and File (b) does not yet exist on the first compute system 406 or central storage 404.

Upon completion of the third workload, and as a result of the third workload operating on File (a) 424, File (b) 428 is created and saved to the first compute system 406.

File (a) 424 may, for example, be a PDF and File (b) 428 may, for example, be an optical character recognition (OCR) PDF. According to such an exemplary hypothetical, the third workload operates on the PDF 424 to create new file (OCR PDF 428) therefrom. Other scenarios beyond PDF scenarios are envisioned. For example, the third workload may operate on existing files (e.g., file (a) 424 or file (a′) 426) along with outside information (e.g., information gathered from the internet) to create the new file (File (b) 428).

Referring back to Example V, after the new File (b) 428 is created, the synchronization system 402 automatically determines that File (b) 428 exists on the first compute system 406, but File (b) does not exist on central storage 404 (see initial conditions). As such, the synchronization system 402 automatically initiates the third workload transfer 414, and File (b) 428 is copied to central storage 404 as File (b) 440. Once copied to central storage 404, the copy of File (b) 440 on central storage 404 will be accessible to each compute system 406-408.

The synchronization system 402 has again effectively and efficiently managed workload files.

### EXAMPLE VI

The initial conditions for Example V follow: a workload on the first compute system 406 was initiated to create File (a′) 426, another workload was initiated on the second compute system 408 to create File (a′) 432 on the second compute system 408; File (a′) 432 on the second compute system 408 is created before File (a′) 426; and File (a′) does not yet exist on central storage 404.

As set forth in the initial conditions of Example VI, a separate workload operates on each compute system 406-408 and File (a′) 426 and File (a′) 432 are created. The workloads that created the respective files, 426, 432, need not be running simultaneously. Indeed the workloads may have operated on the same day or on different days.

Nonetheless, according to the initial conditions, File (a′) 432 of the second compute device 408 was the first to be created. Upon creation, the synchronization system 402 automatically determines that File (a′) 432 exists on the first compute system 406, but File (a′) does not exist on central storage 404 (see initial conditions). As such, the synchronization system 402 automatically initiates the sixth workload transfer 420, and File (a′) 432 is copied to central storage 404 as File (a′) 438.

Later, after File (a′) 426 is created on the first compute system 404, the synchronization system 402 automatically determines that File (a′) 426 exists on the first compute system 406 and File (a′) 436 exists on central storage 404. In response, the synchronization system 402 automatically compares a hash of File (a′) 426 residing on the first compute system 406 with a hash of File (a′) 436 residing on central storage 404.

If the hashes are the same, the synchronization system 402 will not initiate a workload file transfer to replace File (a′) 436 on central storage 404. Accordingly, a redundant file transfer is avoided.

If, on the other hand, the synchronization system 402 determines the hashes are different, the synchronization system 402 will automatically initiate a workload file transfer to copy File (a′) 426 to central storage 404 to overwrite File (a′) 436 already stored thereon. In other words, if the synchronization system 402 determines the files are different, the system will automatically overwrite the file on central storage 402 with the file from the first compute device 406.

Accordingly, the synchronization system 402 efficiently and reliably manages files and updates as necessary, while also avoiding redundant downloads (and uploads).

### EXAMPLE VII

The initial conditions for Example VII follow: a workload on the second compute system 408 was initiated to create File (a″); Files (a) and (a′) do not exist on the second compute system 408; File (a′) 436 exists on central storage 404; and File (a″) does not exist on central storage 404.

In light of the initial conditions of Example VII, and since the workload of the second compute system 408 needs to operate on File (a′) to create File (a″), the synchronization system 402 automatically provides File (a′) to the second compute system 408 by initiating the sixth workload file transfer 418 to copy File (a″) 438 from central storage 404 to the second compute system 408. Accordingly, File (a′) is copied onto the second compute system 408 as File (a′) 432.

The workload of the second compute system 408 then operates on the File (a′) 432 to modify it to File (a″) 434. Upon creation of File (a″) 434, the synchronization system 402 will automatically determines that File (a″) does not exist on central storage 404 (see initial conditions). The synchronization system 402, therefore, automatically copies File (a″) 434 from the second compute system 408 via the sixth workload file transfer 420 to central storage 404. As such, File (a″) 438 is created on central storage 404.

Example VII illustrates another example of the synchronization system 402 efficiently managing central storage 404 to keep it current and up-to-date. Users, therefore, need not manually organize files to ensure the most current files are being employed during workloads. Further, redundant file transfers can be minimized.

As discussed above, workload file transfers 410-420 are merely exemplary. They were discussed to illustrate various exemplary operations of the synchronization system. Further, Examples I-VII above are not limiting. Other exemplary situation can be created to illustrate operation of the synchronization system.

Next, the synchronization system can carry out other operations to ensure file integrity. For example, if corrupted files are transferred to central storage (due to a crash or some other reason), the synchronization system can employ checkpoint features to determine if corruption occurred. Thus, the corrupted files can be isolated so as not to create other problems.

While examples presented above dealt with a single user, the synchronization system is configured to operate with multiple users effectively simultaneously. For example, volumes can be created for each user or groups of users and the synchronization system can operate with each volume.

Various examples and embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a computer, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A non-transitory computer-readable medium storing instructions executable by a hardware processor to:
automatically present a workload input file to a plurality of third-party compute systems, wherein the workload input file is operated on by workloads of the compute systems; and
automatically identify one or more output files generated by one or more of the third-party compute systems.

2. The non-transitory computer-readable medium of claim 1 storing further instructions executable by the hardware processor to:
automatically identify one or more workload output files that are different than the workload input file.

3. The non-transitory computer-readable medium of claim 2 wherein to automatically identify the one or more workload output files that are different than the workload input file comprises hashing at least one workload input file stored on a central storage device and hashing at least one workload output file stored on one or more of the plurality of third-party compute systems

4. The non-transitory computer-readable medium of claim 1 storing further instructions executable by the hardware processor to:
automatically copy the one or more output files generated by one or more of the third-party compute systems, wherein the files are automatically copied by a synchronization system remote from the third-parties.

5. The non-transitory computer-readable medium of claim 1 storing further instructions executable by the hardware processor to:
avoid copying output files that are unchanged from the workload input file.

6. The non-transitory computer-readable medium of claim 1 wherein the workload input file replaces an already existing workload input file on one or more of the compute systems.

7. The non-transitory computer-readable medium of claim 1 wherein one or more of the plurality of third-party compute systems is a cloud computing system.

8. The non-transitory computer-readable medium of claim 1 wherein one or more of the plurality of third-party compute systems is a bare-metal computing system.

9. A system comprising:
a central storage device; and
a synchronization system configured to:
automatically present workload input file(s), from the central storage device, to to a plurality of third-party compute systems;
automatically copy one or more workload output files to the central storage device, wherein the workload output files are copied from one or more of the third-party compute systems.

10. The system of claim 9, the synchronization system further configured to automatically identify one or more workload output files that are different than the workload input file.

11. The system of claim 9, the synchronization system further configured to automatically copy the one or more output files generated by one or more of the third-party compute systems, wherein the files are automatically copied by a synchronization system remote from the third-parties.

12. The system of claim 9, the synchronization system further configured to avoid copying output files that are unchanged from the workload input file.

13. The system of claim 9, wherein one or more of the plurality of third-party compute systems is a cloud computing system.

14. The system of claim 9, wherein one or more of the plurality of third-party compute systems is a bare-metal computing system.

15. The system of claim 9, the synchronization system further configured to automatically identify one or more output files generated by one or more of the third-party compute systems.

16. A method comprising:
automatically presenting a workload input file to a plurality of third-party compute systems, wherein the workload input file is operated on by workloads of the compute systems; and
automatically identifying one or more workload output files generated by one or more of the third-party compute systems.

17. The method of claim 16 further comprising automatically identifying one or more workload output files that are different than the workload input file.

18. The method of claim 16 further comprising automatically copying the one or more output files generated by one or more of the third-party compute systems, wherein the files are automatically copied by a synchronization system remote from the third-parties.

19. The method of claim 15 further comprising avoiding copying output files that are unchanged from the workload input file.

20. A system comprising:
A synchronization system configured to:
identify a first workload file on a central storage;
identify a first workload file on a compute system remote from the central storage;
determine that the first workload file on the central storage is different than the first workload file on the compute system; and
automatically copy the first workload file on the central storage to the compute system so that a compute system workload will be performed using the copy of the first workload file from the central storage and the compute system workload will not be performed using the first workload file on the compute system.

21. The system of claim 21, the synchronization system further configured to:
determine that a second workload file exists on the compute system and the second workload file does not exist on the central storage; and
automatically copy the second workload file from the compute system to the central storage.
